(19) United States
(12) Patent Application Publication
(10) Pub. No.: US 2008/0312014 A1
(43) Pub. Date: Dec. 18, 2008

(54) Drive Wheel of an Auxiliary Unit Pulley of an Internal Combustion Engine

(75) Inventors: Hermann Stief, Emskirchen (DE); Ralf Walter, Aachen (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: SCHAEFFLER KG, Herzogenaurach (DE)

(21) Appl. No.: 12/096,810

(22) PCT Filed: Dec. 4, 2006
(86) PCT No.: PCT/EP2006/069243

§ 371 Date: Jul. 17, 2008

(30) Foreign Application Priority Data
Dec. 10, 2005 (DE) 10 2005 059 030.6

(51) Int. Cl. F16H 55/36; F16D 23/00; F16F 15/12

(52) U.S. Cl. 474/94; 192/41 S

(57) ABSTRACT

A drive wheel of an auxiliary unit pulley of an internal combustion engine is provided, having a rotatable sleeve which is operatively connected to a traction mechanism, having a hub which is rotationally fixed to the drive input axle of an auxiliary unit. A damping device is arranged between the rotatable sleeve and the hub for reducing torsional vibrations. In order to obtain improved damping of torsional vibrations together with increased operational reliability, the damping device (4) includes a series arrangement of a spring storage device (5) and a slip clutch (6), wherein the spring storage device (5) is arranged to act between the rotatable sleeve (2) and a driver disk (8) which is rotatably mounted on the hub (3), and the slip clutch (6) is arranged to act between the driver disk (8) and the hub (3).

### BACKGROUND

The invention relates to a drive wheel of an auxiliary unit pulley of an internal combustion engine, with a rotatable sleeve in active connection with a traction mechanism, with a hub locked in rotation with the drive axle of an auxiliary unit, and with a damping device actively arranged between the rotatable sleeve and the hub for reducing torsional vibrations.

Internal combustion engines constructed as piston engines have, in a known way, rotational variations, which appear from their crankshaft depending on their construction and operation and which are each superimposed on the average rotational speed. These rotational variations are each caused by the non-uniform force generation in the individual cylinders and by free mass moments of the crank drive, wherein their amplitudes and frequencies are dependent on the number of cylinders, the arrangement of the cylinders, such as in-line, V-type, or boxer arrangement, the operating mode, such as gasoline or diesel operation, and the rotational speed. Due to the rotational variations of the crankshaft, undesired torsional vibrations are transferred both into a drive train coupled to the internal combustion engine and also into an auxiliary unit pulley arranged directly on the internal combustion engine.

For decreasing the effects of torsional vibrations of the crankshaft of piston engines, it is known to provide the internal combustion engines with at least one compensation shaft driven by the crankshaft and/or with a two-mass flywheel arranged on the crankshaft or with a starter generator integrated into the flywheel with an electromagnetic vibration damping function. Such devices, however, are very complicated and accordingly expensive, and they disadvantageously increase the weight and also the installation size of the internal combustion engine. Incidentally, the rotational irregularities of the crankshaft cannot be completely eliminated but instead only lessened.

Therefore, for avoiding undesired torsional vibrations within an auxiliary unit pulley of an internal combustion engine, devices for their reduction or damping are useful and sometimes even absolutely necessary at these locations. For this purpose, there can be a damping device for reducing torsional vibrations of the traction mechanism on the crankshaft-side drive wheel, on a tensioning device of the traction mechanism, and/or on the drive wheel of an auxiliary unit, such as that of a generator, a power-steering pump of a power-assisted steering system, and/or an air-conditioner compressor of an air-conditioning system.

In DE 196 62 730 A1, a drive wheel of an auxiliary unit pulley provided for the arrangement on a crankshaft is described, whose damping device comprises a spring storage device, a friction damper, and an oscillation damper. The use of such a drive wheel does indeed counteract the torsional vibrations of the relevant auxiliary unit pulley at the source, namely at the drive wheel of the crankshaft. However, through the arrangement of the components—the components of the friction damper and the oscillation damper are staggered in the axial direction and arranged outside of the components of the spring storage device in the radial direction—a relatively large diameter of the drive wheel is disadvantageously produced. Also, the drive wheel has a relatively complicated construction and therefore is made from many individual parts, by which the production expense is unfavorably high.

Fluctuations in speed, tensile strain, and length of the traction mechanism of an auxiliary unit pulley caused by torsional vibrations of the crankshaft can be compensated and damped at least partially also through tensioning devices. Such tensioning devices are known in various configurations and arrangements, in particular, with hydraulic tensioning elements. These tensioning devices, however, usually have relatively complicated configurations and require a lot of installation space, which is usually not available due to the tightness in the engine compartment and the number of auxiliary units in modern motor vehicles.

Therefore it is frequently inevitable to also provide the drive wheels of the auxiliary units each with a damping device for reducing torsional vibrations. This applies especially to the drive wheel of the generator, which has a relatively large moment of inertia and thus cannot always follow the torsional vibrations of the crankshaft or the fluctuations in tension and speed of the crankshaft, which can lead, for a belt drive, to slippage of the traction mechanism, which is associated with wear and unpleasant noises.

A first drive wheel provided on an auxiliary unit with a damping device is known from DE 101 51 795 A1. For this drive wheel, its rotatable sleeve is roller mounted on a hub and the damping device comprises a free engine clutch arranged between the rotatable sleeve and the hub and also a slip clutch arranged actively parallel to this free engine clutch. Due to the free engine clutch, the hub is decoupled from this clutch for a drive-related deceleration of the rotatable sleeve, wherein the slip clutch has the effect that this happens only when a preset limiting torque is exceeded. Smaller fluctuations in rotational number and torque are thus transmitted without damping from the traction mechanism via the drive wheel to the auxiliary unit. For larger fluctuations in torque, the decoupling is realized only on one side for a relative deceleration of the rotatable sleeve relative to the hub, whereas for a relative acceleration of the rotatable sleeve, a transfer of the rotational movement is realized without damping through the then closed free engine clutch. Through the temporary hard closing of the free engine clutch, disadvantageously a load spike is generated, which can likewise lead to a stimulation of fluctuations in torque and rotational speed.

Another such drive wheel is described in U.S. Pat. No. 6,083,130. In this known drive wheel, the rotatable sleeve is likewise roller mounted on the hub. The damping device, however, is now formed by a series arrangement of a free engine clutch and a spring storage device. The spring storage device can be configured selectively as a helical spring or as a spiral spring and is actively arranged between the free engine clutch arranged on the rotatable sleeve and the hub. Due to the free engine clutch, the hub is decoupled from the rotatable sleeve for a decelerated rotatable sleeve, wherein load spikes caused by the sudden decoupling and coupling of the free engine clutch are damped by the spring storage device. If the spring storage device breaks, however, the force transfer is interrupted, so that the associated auxiliary unit is then no longer driven.

In addition to the essentially one-sided action of the vibration damping by the free engine clutch used in each case and their abrupt coupling and decoupling behavior, both known drive wheels have the disadvantage of a relatively complicated and installation space-intensive configuration.

### SUMMARY

Therefore, the object of the present invention is to provide a drive wheel of the type noted above allocated to an auxiliary unit, which has improved damping of torsional vibrations in connection with increased operational reliability for a simple and space-saving configuration.

The invention is based on the recognition that smaller fluctuations in torque and rotational speed can be compensated in a simple and space-saving way by a spring storage device acting as a spring damper and larger torque fluctuations can be effectively eliminated by a slip clutch acting as a friction damper.

The object forming the basis of the invention is therefore met by a drive wheel of an auxiliary unit pulley of an internal combustion engine, with a rotatable sleeve in active connection with a traction mechanism, with a hub locked in rotation with the drive axle of an auxiliary unit, and with a damping device actively arranged between the rotatable sleeve and the hub for reducing torsional vibrations, which is characterized, in particular, in that the damping device comprises a serial arrangement of a spring storage device and a slip clutch, wherein the spring storage device is actively arranged between the rotatable sleeve and a driver disk mounted so that it can rotate on the hub and also the slip clutch is actively arranged between the driver disk and the hub.

Advantageous configurations of the drive wheel according to the invention are specified in Claims 2 to 12.

Through the series arrangement of the spring storage device and the slip clutch, smaller fluctuations in torque and rotational speed, which are transferred from the traction mechanism to the rotatable sleeve, are compensated in a flexible way and only larger fluctuations in torque and rotational speed are transferred to the driver disk and from there to the slip clutch, where these are compensated and thus damped by frictional slip.

The spring storage device is advantageously formed from several curved springs, which are guided in half-open ring chambers of the rotatable sleeve and the driver disk opposite each other in the axial direction and which alternately contact at their ends a peripheral-side contact face of a driver cam of the rotatable sleeve and a driver cam of the driver disk.

In this way, a very compact configuration of the spring storage device is produced, which allows its arrangement within the rotatable sleeve. The curved springs represent compression springs, which are tensioned for a simple arrangement in the pulling operation of the drive wheel, that is, for a relative acceleration of the rotatable sleeve relative to the hub, and which are relieved of tension for a relative deceleration of the rotatable sleeve relative to the hub. Here, high functional reliability is produced in that the force transfer is also guaranteed for a rupture of a curved spring, because in this case the windings of the spring parts and in the extreme case the driver cams contact each other and thus guarantee the transfer of torque.

For achieving a symmetric action, however, it is also possible to actively arrange several spring elements each alternating on the peripheral side between the rotatable sleeve and the driver disk, so that a first group of spring elements is tensioned in the pulling operation of the drive wheel and a second group of spring elements is tensioned in the pushing operation of the drive wheel. Here, through the use of spring elements of differing spring stiffness, a desired asymmetry of the damping effect of the spring storage device can be achieved in the two groups.

The slip clutch preferably has an annular disk-shaped friction ring, which is arranged between a corresponding friction surface of the driver disk and a disk spring locked in rotation and supported on the hub in the axial direction. Here, the locked rotational connection of the disk spring with the hub can be formed in a simple and space-saving way through several teeth, which are arranged with equal spacing on the inner periphery of the disk spring, which project inward in the radial direction, and which engage in corresponding axial grooves of the hub.

Likewise, the axial support of the disk spring on the hub can be produced in a simple way by a safety ring that can be inserted into a ring groove of the hub, wherein, for improving the force transfer a support ring can be arranged between the disk spring and the safety ring.

The maximum transferable friction moment of the slip clutch is preferably set to a permissible limiting torque of the associated auxiliary unit, so that the slip clutch, apart from the friction damper, is also active as a safety coupling for protecting the auxiliary unit and the auxiliary unit pulley from an overload.

The driver disk is advantageously configured with a pot shape on the coupling side with a cylindrical casing and a circular disk-shaped base, in whose interior the slip clutch is arranged and is sealed for protection from penetrating water and contaminants, preferably with a cover bordering the outer edge of the casing.

For further simplification of the configuration and for saving installation space, the rotatable sleeve and the driver disk are advantageously mounted in a sliding way on the hub and relative to each other. The slide bearing can be configured in such a way that, for example, the rotatable sleeve and the driver disk are each supported in the radial direction on the hub by an inner radial bearing surface, and the rotatable sleeve is supported in the axial direction by axial bearing surfaces arranged on both sides relative to a radial projection of the hub and an axial bearing surface of the driver disk, or that the rotatable sleeve has conical ring-shaped bearing surfaces on both sides in the axial direction and is mounted between a conical ring-shaped projection of the hub and a corresponding conical ring-shaped bearing surface of the driver disk.

The construction described above produces a drive wheel of an auxiliary unit pulley allocated to an auxiliary unit, which has, in comparison to known configurations, increased operational reliability and improved damping properties. In addition, the drive wheel according to the invention is constructed with relatively few components in a simple, economical, and space-saving way.

### BRIEF DESCRIPTION OF THE DRAWINGS

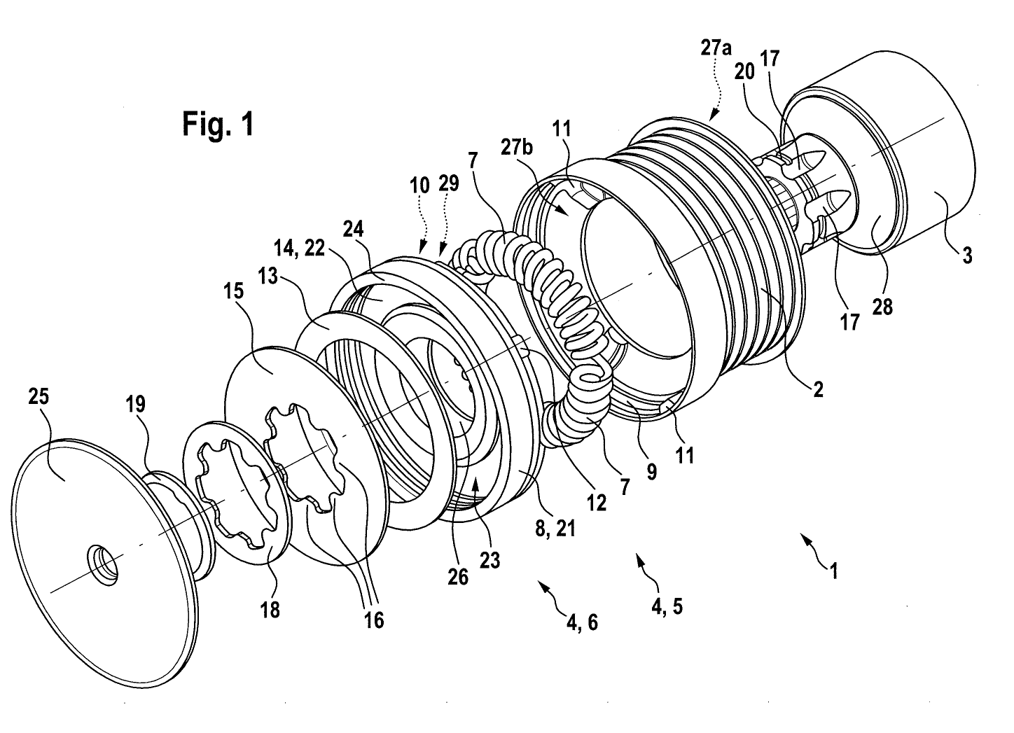

The invention will be explained in more detail below with reference to the enclosed drawing using an embodiment. Shown is FIG. 1, which is an exploded view of a preferred configuration of a drive wheel of an auxiliary unit pulley.

### DETAILED DESCRIPTION OF THE PREFERRED EMBODIMENT

A drive wheel 1 of an auxiliary unit pulley allocated to an auxiliary unit, for example, a generator, comprises a rotatable sleeve 2 in active connection with a traction mechanism, a hub 3 locked in rotation with the drive axle of the auxiliary unit, and a damping device 4 actively arranged between the rotatable sleeve 2 and the hub 3 for reducing torsional vibrations.

On its outer periphery, the rotatable sleeve 2 has contours adapted to the traction mechanism that is used, wherein in the present case a V-ribbed belt is provided as the traction mechanism. The damping device 4 is formed from a series arrangement of a spring storage device 5 and a slip clutch 6. The spring storage device 5 comprises several curved springs 7, which are arranged between the rotatable sleeve 2 and a driver disk 8 mounted so that it can rotate on the hub 3 and which are guided in half-open ring chambers 9, 10 opposite each other in the rotatable sleeve 2 and the driver disk 8, and which alternately contact at their ends a peripheral-side contact face of a driver cam 11 of the rotatable sleeve 2 and a driver cam 12 of the driver disk 8.

The slip clutch 6 is arranged on the side facing away from the spring storage device 5 in the axial direction between the driver disk 8 and the hub 3 and has an annular disk-shaped friction ring 13, which is arranged between a friction surface 14 of the driver disk 8 and a disk spring 15. The disk spring 15 is locked in rotation and supported in the axial direction on the hub 3 by several teeth 16, which are arranged with equal spacing on its inner periphery and which project inwardly in the radial direction and which are provided for engaging in corresponding axial grooves 17 of the hub 3, and via a support ring 18 and a safety ring 19, which is provided for engaging in a ring groove 20 of the hub 3.

The driver disk 8 has a pot-shaped configuration and accommodates the slip clutch 6 in the inner space 23, which is bounded by the cylindrical casing 21 and the circular disk-shaped base 22 and which is sealed for protection from penetrating contaminants and water with a cover 25 bordering the outer edge 24 of the casing 21.

While the driver disk 8 is set on the hub 3 in the radial direction using an inner radial bearing surface 26, the rotatable sleeve 2 has conical ring-shaped bearing surfaces 27a and 27b on both sides in the axial direction, by which it is supported in a suspended way between a corresponding conical ring-shaped projection 28 of the hub 3 and a corresponding conical ring-shaped bearing surface 29 of the driver disk 8.

Smaller fluctuations in rotational speed and torque transferred from the traction mechanism to the rotatable sleeve 2 are damped by the spring storage device 5 acting as a spring damper and thus kept away from the hub 3 and the auxiliary unit connected to this hub. For larger rotational speed and torque spikes, the slip clutch 6 acting as a friction damper temporarily enters slip operation, so that the auxiliary unit is protected in this way from such load spikes and slippage due to inertia of the traction mechanism is reliably prevented on the rotatable sleeve 2. Here, the drive wheel 1 according to the invention has an especially simple and compact configuration with relatively few components.

### LIST OF REFERENCE SYMBOLS

1 Drive wheel
2 Rotatable sleeve
3 Hub
4 Damping device
5 Spring storage device
6 Slip clutch
7 Curved spring, spring element
8 Driver disk
9 Ring chamber
10 Ring chamber
11 Driver cam
12 Driver cam
13 Friction ring
14 Friction surface
15 Disk spring
16 Tooth
17 Axial groove
18 Support ring
19 Safety ring
20 Ring groove
21 Casing
22 Base
23 Inner space
24 Outer edge
25 Cover
26 Radial bearing surface
27a Bearing surface
27b Bearing surface
28 Projection
29 Bearing surface

1. Drive wheel of an auxiliary unit pulley of an internal combustion engine, comprising a rotatable sleeve in active connection with a traction mechanism, a hub locked in rotation with a drive axle of an auxiliary unit, and a damping device arranged actively between the rotatable sleeve and the hub for reducing torsional vibrations, the damping device comprises a series arrangement of a spring storage device and a slip clutch, wherein the spring storage device is actively arranged between the rotatable sleeve and a driver disk mounted for rotation on the hub and the slip clutch is actively arranged between the driver disk and the hub.

2. Drive wheel according to claim 1, wherein the spring storage device has at least one curved spring, which is guided in half-open ring chambers of the rotatable sleeve and the driver disk that are located opposite each other in an axial direction and which alternately contacts at its ends a peripheral-side contact face of a driver cam of the rotatable sleeve and a driver cam of the driver disk.

3. Drive wheel according to claim 1, wherein the spring storage device has several spring elements, which are actively arranged alternating on a peripheral side between the rotatable sleeve and the driver disk.

4. Drive wheel according to claim 1, wherein the slip clutch has an annular disk-shaped friction ring, which is arranged between a corresponding friction surface of the driver disk and a disk spring locked in rotation and supported in the axial direction on the hub.

5. Drive wheel according to claim 4, wherein the disk spring has several teeth, which are spaced equally on its inner periphery and which project inwardly in the radial direction and which are provided for engaging in corresponding axial grooves of the hub.

6. Drive wheel according to claim 4, wherein a safety ring that can be inserted into an annular groove of the hub is provided for axial support of the disk spring.

7. Drive wheel according to claim 1, wherein a maximum transferable friction moment of the slip clutch is set to a permissible limiting torque of the associated auxiliary unit.

8. Drive wheel according to claim 1, wherein the driver disk has a pot-shaped configuration with a cylindrical casing and a circular disk-shaped base, and the slip clutch is arranged within an inner space of the driver disk bounded by the casing and the base.

9. Drive wheel according to claim 8, wherein the inner space of the driver disk is sealed with a cover bordering an outer edge of the casing.

10. Drive wheel according to at claim 1, wherein the rotatable sleeve and the driver disk are mounted in a sliding way relative to each other and on the hub.

11. Drive wheel according to claim 10, wherein the rotatable sleeve and the driver disk are each supported in a radial direction by an inner radial bearing surface on the hub and the rotatable sleeve is supported in an axial direction by axial bearing surfaces on both sides relative to a radial projection of the hub and an axial bearing surface of the driver disk.

12. Drive wheel according to claim 10, wherein the rotatable sleeve has conical ring-shaped bearing surfaces on both sides in the axial direction and is supported in a suspended manner between a conical ring-shaped projection of the hub and a corresponding conical ring-shaped bearing surface of the driver disk.
